(19) United States
(12) Patent Application Publication
(10) Pub. No.: US 2005/0151886 A1
(43) Pub. Date: Jul. 14, 2005

(54) Remote controller

(75) Inventor: Kazuhisa Hirano, Saitama (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/023,402

(22) Filed: Dec. 29, 2004

(30) Foreign Application Priority Data
Jan. 8, 2004 (JP) 2004-003492

(51) Int. Cl. H04N 5/44

(52) U.S. Cl. 348/734

(57) ABSTRACT

A remote controller controlling a television set as a main video apparatus and a video cassette recorder and a DVD player as sub video apparatuses. The remote controller includes a remote-control transmitter including an input terminal selection key for selecting one of sub video apparatuses connected to the main video apparatus. When a signal from one of the sub video signals is selected, the remote controller generates a remote control code signal compatible with the sub video apparatus selected in response to an operation of an operation key of the remote-control transmitter so that an infrared blaster operates the sub video apparatus.

### CROSS-REFERENCE TO RELATED APPLICATIONS

This application is based upon and claims the benefit of priority from the prior Japanese Application No. 2004-3492 filed in Japan on Jan. 8, 2004; the entire contents of which are incorporated herein by reference.

### BACKGROUND OF THE INVENTION

1. Field of the Invention

The present invention relates to a remote controller with a single remote-control transmitter for operating a main video apparatus and sub video apparatuses, such as a video cassette recorder (VCR), a digital versatile disk (DVD) player, and a broadcasting satellite (BS) tuner, each connected to the main video apparatus.

2. Description of the Related Art

Video apparatuses, including a television receiver (hereinafter referred to as a TV set), a VCR, a DVD player, and a BS tuner, are remote controlled using a remote control transmitter for respective apparatuses.

The main video apparatus is used with the additional or sub video apparatus connected thereto. The main video apparatus may be a TV set, and the sub video apparatuses may include a VCR, a DVD player, a BS tuner, and the like. The TV set has a plurality of external input terminals, to which the VCR, the DVD player, the BS tuner, and the like can be connected via signal cables.

For example, a remote control process is performed with the VCR connected to a first external input terminal of the TV set, and with the DVD player connected to a second external input terminal. To play video and audio signals on the VCR, a remote-control transmitter for the TV set is operated to select the video and the audio signal from the VCR connected to the first external input terminal of the TV set. A remote-control transmitter for the VCR is operated to cause the VCR to play.

To play video and audio signals from the DVD player, the remote-control transmitter of the TV set is first operated to select the video and the audio signal from the DVD player connected to the second external input terminal of the TV set. A remote-control transmitter of the DVD player is then operated to cause the DVD player to play.

The known art requires the TV set remote-control transmitter for operating the TV set, the VCR remote-control transmitter for operating the VCR, and the DVD remote-control transmitter for operating the DVD player. Each time each apparatus is operated, the respective dedicated remote-control transmitter must be used.

Operating the dedicated remote-control transmitters for the respective apparatuses inconveniences users. Some of the remote-control transmitters are of the type that a single remote-transmitter thereof controls a plurality of video apparatuses. For example, the remote-control transmitter capable of controlling a plurality of apparatuses includes an external input switch key for selecting between a VCR and a DVD player, connected to the external terminals of a TV set, a plurality of operation keys that are commonly shared to the most extent by the TV set, the VCR, and the DVD player for operation, and a mode selection switch corresponding to each apparatus to be remote-controlled.

The operation keys commonly shared by the VCR and the DVD player include a replay key, a stop key, a fast forward key, and a rewind key. The remote-control transmitter then outputs a remote control signal compatible with a video apparatus selected by the mode selection switch. For example, when a VCR mode is selected, the VCR plays in response to the selection of the play key. When a DVD player mode is selected, the DVD player plays in response to the selection of the play key.

However, such a remote-control transmitter can cause an apparatus different from the intended one to operate if the operation of the mode selection switch is in error. For example, when the mode selection switch is manipulated to operate the VCR, a user can erroneously activate the DVD player. A key input intended to operate the VCR could erroneously activate a mode to cause the DVD player to operate.

For example, Japanese Published Patent Application No. 2001-128263 discloses a remote controller that simplifies a mode selection operation in a manner free from misoperation. A system using the disclosed remote controller includes a TV set as a main control apparatus and a VCR, a DVD player, and a BS tuner, as controlled apparatuses, connected to the main control apparatus via an IEEE1394 network. Each of the main control apparatus and the controlled apparatus includes an assignment information database and an assignment information searching unit, and furthermore stores information of an operation function that is assigned to a key of a remote-control transmitter for each of the main control apparatus and the controlled apparatus. The remote-control transmitter of the main control apparatus includes an apparatus selection key for selecting the main control apparatus or the controlled apparatus in control process, operation keys for performing a variety of remote control operations in a mode of the apparatus selected by the apparatus selection key, and an input switch key for switching signals input to the main control apparatus from the controlled apparatus.

The disclosed remote controller is designed to transmit a remote control code of a controlled apparatus when controlled apparatus connected to the main control apparatus is selected by the apparatus selection key. Upon receiving the remote control code of the controlled apparatus transmitted from the remote-control transmitter, the main control apparatus converts the remote control code into a control command of the controlled apparatus in accordance with the assignment information stored on a per controlled apparatus basis. The main control apparatus then transmits the control command to the controlled apparatus via an IEEE1394 network. The remote-control transmitter performs a switching operation so that a replay signal from the controlled apparatus selected by the input switch key is input to the main control apparatus.

The remote-control transmitter must perform an apparatus selection process for outputting a remote control signal for operating the selected controlled apparatus and an input switching process for inputting the replay signal from the selected controlled apparatus to an input terminal of the main control apparatus.

The user can forget operating the input switching key, for example, even if a VCR is selected by the apparatus selection key. The VCR is remote controlled. If the input switch key on the TV set is not correctly operated, a video from the VCR will not be displayed. The user may mistake this misoperation for a failure in the TV set or the VCR.

### SUMMARY OF THE INVENTION

Accordingly, it is an object of the present invention to provide a remote controller in a system including a main video apparatus, a plurality of sub video apparatuses connected to the main video apparatus, and the remote controller having a remote-control transmitter, wherein when sub video apparatuses connected to the main video apparatus are selected using the remote-control transmitter, one of the sub video apparatuses that inputs a signal to the main video apparatus is selected, and the remote controller performs a remote control operation in an operation mode of the selected sub video apparatus.

According to a first aspect of the present invention, a remote controller includes registering means for registering information of a remote control signal concerning a main video apparatus and at least one sub video apparatus respectively connected to at least one external input terminal on the main video apparatus, transmitting means for transmitting the remote control signal in each of transmission modes of the main video apparatus and the at least one sub video apparatus based on the registration of the registering means, selecting means for causing the transmitting means to transmit the remote control signal for selecting a signal to be captured into the main video apparatus through the external input terminal in response to a selection operation that is performed to select one of the at least one sub video apparatus as an external input source to the main video apparatus, and mode setting means for setting, in the transmitting means, the transmission mode of the at least one sub video apparatus from among the transmission modes corresponding to the selection operation, in response to the selection operation that is performed to select one of the at least one sub video apparatus as the external input source to the main video apparatus.

According to a second aspect of the present invention, a remote controller includes registering means for registering information of a remote control signal concerning a main video apparatus and at least one sub video apparatus respectively connected to at least one external input terminal on the main video apparatus, transmitting means for transmitting the remote control signal in each of transmission modes of the main video apparatus and the at least one sub video apparatus based on the registration of the registering means, selecting means for causing the transmitting means to transmit the remote control signal for selecting a signal to be captured into the main video apparatus through the external input terminal in response to a selection operation that is performed to select one of the at least one sub video apparatus as an external input source to the main video apparatus, mode setting means for setting, in the transmitting means, the transmission mode of the at least one sub video apparatus from among the transmission modes corresponding to the selection operation, in response to the selection operation that is performed to select one of the at least one sub video apparatus as the external input source to the main video apparatus, input switch means for switching the external input source of the main video apparatus in response to the remote control signal, transmitted from the transmitting means by the selecting means, for selecting the signal to be captured into the main video apparatus, and remote control signal generator means for generating the remote control signal compatible with the transmission mode of the at least one sub video apparatus set by the mode setting means and transmitted from the transmitting means.

The above and other objects, features and advantage of the invention will become more clear from the following description referring to the accompanying drawing.

### BRIEF DESCRIPTION OF THE DRAWINGS

FIG. 1 is a block diagram illustrating a configuration of a remote controller in accordance with an embodiment of the present invention;

FIG. 2 is a front view of a remote-control transmitter of the remote controller in accordance with the embodiment of the present invention;

FIG. 3 is a block diagram illustrating the internal structure of the remote-control transmitter of the remote controller in accordance with the embodiment of the present invention;

FIG. 4 is a block diagram illustrating the internal structure of a remote-control receiver of the remote controller in accordance with the embodiment of the present invention;

FIG. 5 is a flowchart illustrating the initial setting of the remote-control transmitter of the remote controller in accordance with the embodiment of the present invention;

FIGS. 6A-6C illustrate menu screens displayed on a TV set during initial setting of the remote-control transmitter of the remote controller in accordance with the embodiment of the present invention; and

FIG. 7 is a flowchart illustrating a remote control operation of the remote-control receiver of the remote controller in accordance with the embodiment of the present invention.

### DETAILED DESCRIPTION OF EMBODIMENTS OF THE INVENTION

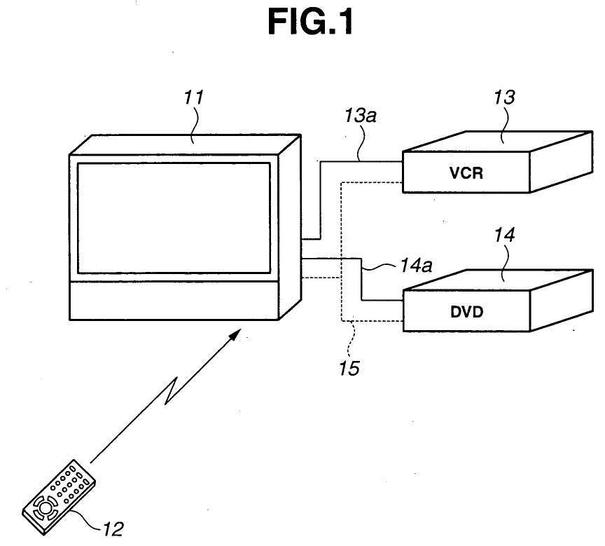

As shown in FIG. 1, a remote controller of one embodiment of the present invention is used in a system including a TV set 11 as a main video apparatus, a remote-control transmitter 12, and a VCR 13 and a DVD player 14 as sub (additional) video apparatuses. The TV set 11 displays a video based on a signal of a broadcast channel selected by a tuner of the TV set 11. The TV set 11 also plays a signal from one of the VCR 13 and the DVD player 14 or a video of a television signal from a BS tuner or a communication satellite (CS) tuner. The TV set 11 plays an audio signal in addition to the video signal.

The TV set 11 includes a plurality of external input terminals for receiving signals from the VCR 13, and the DVD player 14. The VCR 13 is connected to the external input terminal via a signal cable 13a, and the DVD player 14 is connected the external input terminal via a signal cable 13b. IR blasters 15 are arranged one between the TV set 11 and the VCR 13, and the other between the TV set 11 and the DVD player 14. The IR blaster 15 is an adaptor for receiving and transmitting an infrared remote control signal.

The remote-control transmitter 12 transmits an infrared remote control code (remote control signal), thereby operating the VCR 13 and the DVD player 14 in addition to the TV set 11.

The TV set 11 includes a remote-control receiver 31 for receiving the remote control signal from the remote-control transmitter 12.

In addition to the VCR 13 and the DVD player 14, a set-top box having a BS tuner, a CS tuner or a community antenna television (CATV) tuner is also available. In the embodiment of the present invention, the sub video apparatuses are the VCR 13 and the DVD player 14, for example.

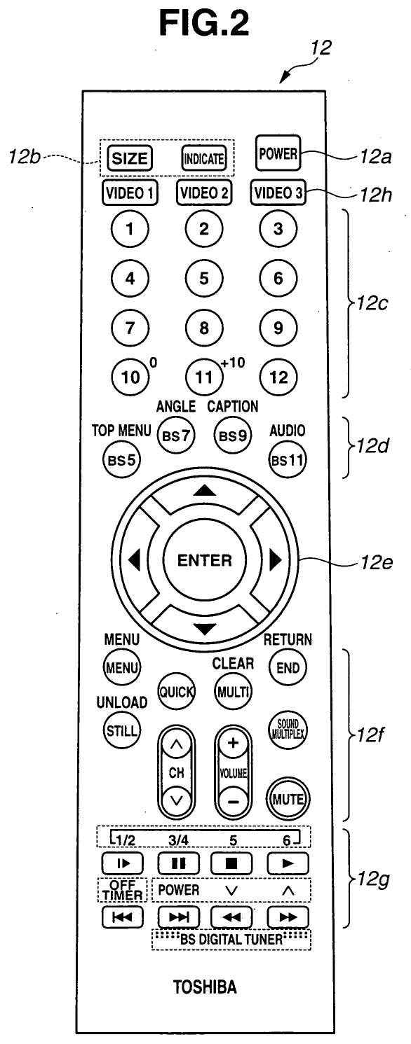

Next, the external structure of the remote-control transmitter 12 is described below with reference to FIG. 2. The remote-control transmitter 12 includes a plurality of operation keys on the front surface thereof. The operation keys include a power key 12a for switching on and off power, a screen display key 12b for controlling the size of a video displayed on the TV set 11 and an indicator of a channel number, channel keys 12c for selecting a ground wave broadcasting channel, BS channel keys 12d for selecting a BS channel, cursor keys 12e including shift keys for scrolling up and down, and left and right, and an enter key, mode selection keys 12f for changing a channel, controlling volume, and selecting modes, sub video apparatus operation keys 12g for controlling the VCR 13 or the DVD player 14 for play, stop, fast forward, and rewind operations, and input terminal selection keys 12h for selecting one of the signals input to the external input terminals of the TV set 11. The operation keys mainly serve as operation keys for the TV set 11, and operation keys used for each of the VCR 13 and the DVD player 14 are commonly shared by the two apparatuses to the most extent. The shared key has on the periphery thereof a label indicating a shared function.

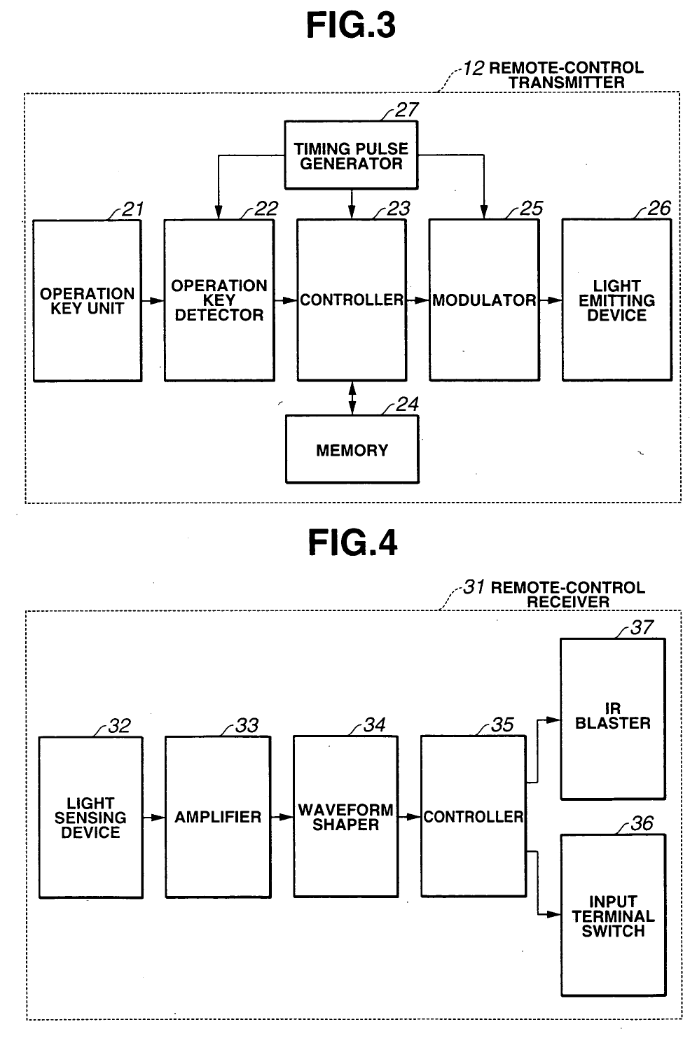

The internal structure of the remote-control transmitter 12 is described with reference to FIG. 3. The plurality of operation keys 12a-12h of FIG. 2 are collectively referred to as an operation key unit 21 as shown in FIG. 3.

The remote-control transmitter 12 includes an operation key detector 22 for detecting the operation of an operation key of the operation key unit 21, a controller 23 including a microprocessor unit (MPU) for generating a remote control code in response to the operation of a key detected by the operation key detector 22, a memory 24 having stored remote control code data of video apparatuses including the TV set 11, the VCR 13, and the DVD player 14, a modulator 25 for modulating the remote control code generated by the controller 23, a light emitting device 26 for transmitting an infrared remote control signal, and a timing pulse generator 27 for generating timing pulses that control driving of the operation key detector 22, the controller 23, and the modulator 25.

The memory 24 stores beforehand the remote control code data of the TV set 11, the VCR 13, the DVD player 14 and other sub video apparatuses. The remote control code data stored in the memory 24 is readable. Alternatively, the memory 24 stores the remote control code data of the TV set 11 only, and when the sub video apparatuses, such as the VCR 13 and the DVD player 14, are connected to the TV set 11, the remote control code data of the connected sub video apparatus is written on the memory 24. The memory 24 can be an integrated circuit (IC) memory card or a memory element chip having stored the remote control code data of the sub video apparatuses connected to the TV set 11.

When any operation key of the operation key unit 21 in the remote-control transmitter 12 is selected, the operation key detector 22 detects the selected key at the timing controlled by the timing pulse generator 27. The operation key detector 22 transfers information of the detected operation key to the controller 23. The controller 23 generates a remote control code assigned to each operation key based on the operation key information from the operation key detector 22 and the remote control code data stored in the memory 24, and outputs the remote control code to the modulator 25. The modulator 25 modulates the remote control code from the controller 23, thereby generating a remote control code signal. The light emitting device 26 outputs the remote control code signal in the form of infrared light.

Next, the remote-control receiver 31 contained in the TV set 11 is described below with reference to FIG. 4. The remote-control receiver 31 receives the infrared remote control code signal transmitted by the remote-control transmitter 12, and decodes the received remote control code signal into a remote control code.

The remote-control receiver 31 includes a light sensing device 32 for receiving the infrared remote control code signal from the remote-control transmitter 12, an amplifier 33 for amplifying the remote control code signal from the light sensing device 32, a waveform shaper 34 for shaping the waveform of the remote control code signal amplified by the amplifier 33, and a controller 35 including a microprocessor unit (MPU) for decoding the remote control code signal shaped by the waveform shaper 34 for demodulation. The remote-control receiver 31 also includes an input terminal switch 36 and an IR blaster 37. The input terminal switch 36 selects between signals of the connected VCR 13 and DVD player 14 by switching one from another among a plurality of external input terminals of the TV set 11 based on the remote control code decoded and demodulated by the controller 35. The IR blaster 37 converts the remote control code of the VCR 13 or the DVD player 14, connected to the external input terminal of the TV set 11, into a remote control command and then transmits the remote control command to the VCR 13 or the DVD player 14.

The remote-control receiver 31 operates in response to the remote control code signal received by the light sensing device 32. The controller 35 generates the remote control commands for the TV set 11, the VCR 13, and the DVD player 14. For example, the remote control command for controlling the TV set 11 is used to perform each operation on the TV set 11. When the remote control command is a command for controlling the VCR 13 or the DVD player 14, the input terminal switch 36 performs a switching operation. The IR blaster 37 generates the infrared signal of the remote control command for the VCR 13 or the DVD player 14, and transmits the infrared signal to the remote-control receiver in the VCR 13 or the DVD player 14.

As shown in FIG. 2, the remote-control transmitter 12 of the remote controller of the embodiment of the present invention includes the input terminal selection keys 12h for selecting one of the video signals of the sub video apparatuses connected to the plurality of external input terminals arranged on the TV set 11. When video 1 of the input terminal selection keys 12h is selected, the remote-control transmitter 12 transmits a remote control code signal for selecting a signal from the VCR 13 connected to the external input terminal corresponding to the video 1. When video 2 of the input terminal selection keys 12h is selected, the remote-control transmitter 12 transmits a remote control code signal for selecting a signal from the DVD player 14 connected to the external input terminal corresponding to the video 2.

By selecting one of the input terminal selection keys 12h of the remote-control transmitter 12, the remote-control receiver 31 recognizes an external input terminal switching signal. The remote-control receiver 31 controls the input terminal switch 36, thereby selecting a signal of the specified external input terminal. The IR blaster 37 outputs the remote control code for operating the VCR 13 or the DVD player 14 connected to the selected external input terminal, thereby remote controlling the VCR 13 or the DVD player 14.

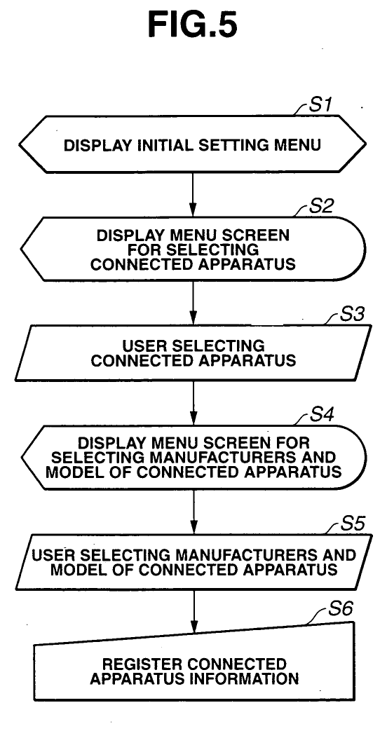

Next, when one of the input terminal selection keys 12h of the remote-control transmitter 12 is selected, the controller 23 controls the VCR 13 or the DVD player 14 connected to the external input terminal of the TV set 11. The operation of the controller 23 is described below with reference to FIG. 5.

FIG. 5 illustrates an initial setting mode to be set by a user. The user sets the sub video apparatus connected to the external input terminal of the TV set 11. For example, the VCR 13 is connected to the video 1 as a first external input terminal of the TV set 11.

In step S1, the user selects a menu key of the mode selection keys 12f of the remote-control transmitter 12. When the menu key is selected, the remote-control transmitter 12 transmits a remote control signal for displaying a menu screen for initial setting to the remote-control receiver 31 of the TV set 11. In response to the display signal for displaying the initial setting menu screen, the remote-control receiver 31 displays an initial setting page on the screen of the TV set 11. Using the cursor keys 12e, the user displays a menu screen from the initial setting menu for setting a sub video apparatus connected to the external input terminal of the TV set 11.

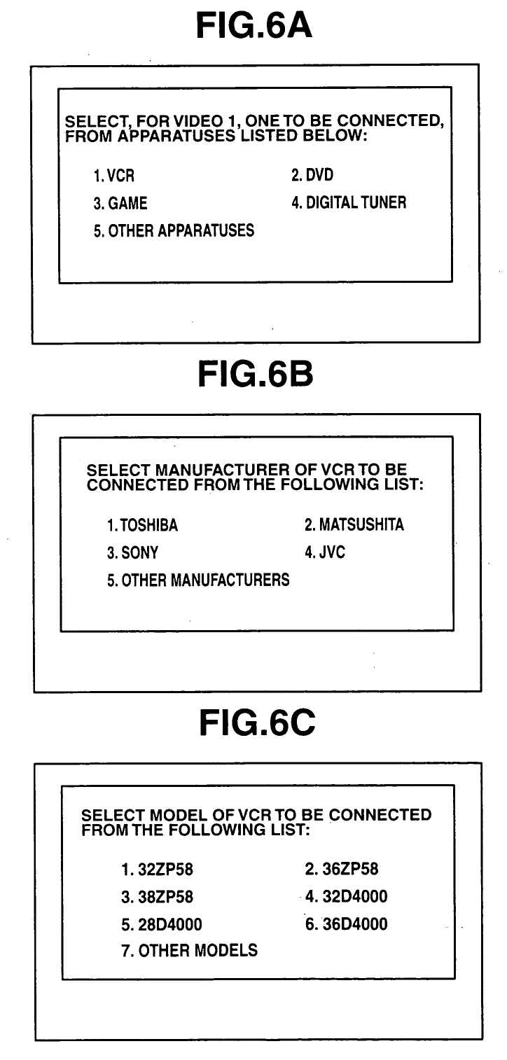

In step S2, an input mode and selection options are displayed on the screen of the TV set 11. As shown in FIG. 6A, an apparatus selection menu page for setting a sub video apparatus to be connected to the first external input terminal (video 1) is displayed.

An apparatus selection menu screen allows the user to select the type of a sub video apparatus connected to the first external input terminal, for example, from VCR, DVD, a game machine, digital tuner, and other apparatuses. The user operates the cursor keys 12e of the remote-control transmitter 12 to select one from VCR, DVD, game machine, digital tuner, and other apparatuses. As a result, the type of the sub video apparatus connected to the video 1 is recognized.

In step S3, the user shifts to a mode on the apparatus selection menu screen to select a sub video apparatus to be connected to the video 1. Using the cursor keys 12e, the user selects VCR, for example.

If the VCR is selected as the sub video apparatus to be connected to the video 1 in step S3, a menu page for selecting the manufacturer and the model of the selected sub video apparatus is displayed in step S4.

As shown in FIG. 6B, a manufacturer selection menu screen of the sub video apparatus lists Toshiba, Matsushita, Sony, JVC, and other manufacturers to allow the user to select one therefrom. Using the cursor keys 12e, the user selects a manufacturer.

As shown in FIG. 6C, a model selection menu screen of the sub video apparatus lists a plurality of model names to allow the user to select one from the models of VCRs of the selected manufacturer. The user selects a model name using the cursor keys 12e.

In step S4, the manufacturer selection menu screen and the model selection menu screen are displayed. In step S5, the user selects the manufacturer and the model of the sub video apparatus of the VCR, connected to the video 1, using the cursor keys 12e.

After the manufacturer and the model are selected in step S5, data concerning the VCR, selected as the sub video apparatus, connected to the video 1, and the manufacturer and the model name of the VCR is registered in the memory 24 of the remote-control transmitter 12.

Likewise, the user sets and registers sub video apparatuses to be connected to second and third external input terminals (video 2 and video 3) of the TV set 11.

Once the initial setting is performed for the sub video apparatuses connected to the external input terminals of the TV set 11, the sub video apparatus is automatically selected by selecting one of the input terminal selection keys 12h of the remote-control transmitter 12. The sub video apparatus selected by the input terminal selection key 12h is controlled.

For example, when the key for the video 1 of the remote-control transmitter 12 is selected, the TV set 11 is switched to select the signal from the VCR 13 connected to the first external input terminal. The remote-control transmitter 12 is set to a remote control mode for the VCR 13. The operation key unit 21 is assigned to the remote control operation of the VCR 13. The remote-control transmitter 12 transmits the remote control code of the VCR 13, thereby allowing the user to control the VCR 13.

The type, the name of the manufacturer, and the model of the sub video apparatus connected to the external input terminal of the TV set 11 are input and set to each of the input terminal selection keys 12h because the remote control code is different depending the video apparatus, the manufacturer, and the model. Each of the input terminal selection keys 12h is selected to retrieve the remote control code matching the connected sub video apparatus from the memory 24. If data of the remote control code matching the sub video apparatus connected to the TV set 11 is not stored in the memory 24 of the remote-control transmitter 12, a remote control code may be newly written onto the memory 24 using a learning function. Instead of the memory 24, an IC memory card or a memory element chip may be used to store the remote control code of each sub video apparatus.

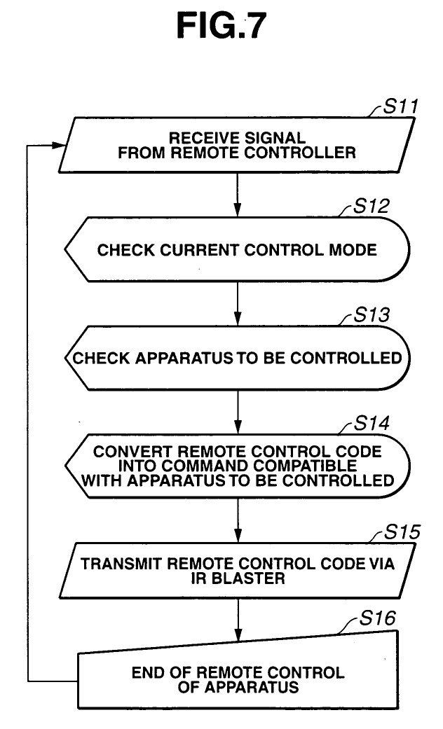

Next, the operation of the remote-control receiver 31 is described with reference to a flowchart of FIG. 7. In step S11, the light sensing device 32 receives the infrared remote control signal from the remote-control transmitter 12. The remote control signal is then amplified by the amplifier 33. The amplified remote control signal is waveform shaped by the waveform shaper 34 before being supplied to the controller 35.

In step S12, the controller 35 checks a current control mode of the remote-control transmitter 12 in accordance with the remote control code data. More specifically, the controller 35 determines, in accordance with the remote control code data transmitted from the remote-control transmitter 12, whether the control mode is a TV mode, a VCR mode of the video 1, or a DVD player mode of the video 2.

In step S13, the controller 35 checks the sub video apparatus to be controlled. After recognizing the sub video apparatus in step S13, the controller 35 converts the remote control code transmitted from the remote-control transmitter 12 into a remote control command appropriate for the operation of the sub video apparatus in step S14. If the remote control code transmitted from the remote-control transmitter 12 is a control code for operating the TV set 11, the input terminal switch 36 does not perform a switching operation. The remote control operation is performed on the TV set 11. If the video 1 of the input terminal selection keys 12h is selected, the input terminal switch 36 selects the signal from the VCR 13, and the remote control code is converted to a remote control command for the VCR 13.

After the remote control code is converted to the remote control command of the VCR 13 in step S14, the IR blaster 37 transmits the remote control command of the VCR 13 to the remote-control receiver of the VCR 13 in step S15. In response to the remote control command transmitted from the IR blaster 37, the VCR 13 operates accordingly. In step S16, the control process of the apparatuses ends.

The remote-control receiver 31 of FIG. 4 includes the IR blaster 37 in the above discussion. If the sub video apparatus can directly receive and decode the remote control code from the remote-control transmitter 12, the IR blaster 37 is not required. An IEEE1394 network may be substituted for the IR blaster 37.

In accordance with the present invention, the single remote-control transmitter 12 selects the sub video apparatus and remote controls the selected sub video apparatus when the VCR 13, the DVD player 14, and the like as the sub video apparatuses are connected to the TV set 11 as the main video apparatus.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

1. A remote controller comprising:
registering means for registering information of a remote control signal concerning a main video apparatus and at least one sub video apparatus connected to at least one external input terminal on the main video apparatus;
transmitting means for transmitting the remote control signal in each of transmission modes of the main video apparatus and the at least one sub video apparatus based on the registration of the registering means;
selecting means for causing the transmitting means to transmit the remote control signal for selecting a signal to be captured into the main video apparatus through the external input terminal in response to a selection operation that is performed to select one of the at least one sub video apparatus as an external input source to the main video apparatus; and
mode setting means for setting, in the transmitting means, the transmission mode of the at least one sub video apparatus from among the transmission modes corresponding to the selection operation that is performed to select one of the at least one sub video apparatus as the external input source to the main video apparatus.

2. A remote controller according to claim 1, further comprising an operation unit including at least one operation key respectively assigned to the at least one external input terminal of the main video apparatus,
wherein the selecting means selects, as an external input, a signal to an external input terminal assigned to a key that is operated from among the operation keys; and
wherein the mode setting means sets the transmission mode of the at least one sub video apparatus connected to the external input terminal to which the operated key is assigned from among the operation keys.

3. A remote controller according to claim 1, wherein the registering means comprises storage means having stored data relating to remote control codes corresponding to the main video apparatus and the at least one sub video apparatus.

4. A remote controller according to claim 1, wherein the registering means comprises storage means having stored data relating to the remote control code of the main video apparatus and ready to write thereon data relating to the remote control code of the at least one sub video apparatus.

5. A remote controller according to claim 1, wherein the registering means registers the information of the remote control signal together with a relationship between the at least one external input terminal of the main video apparatus and the at least one sub video apparatus.

6. A remote controller according to claim 5, wherein the registering means registers data of a remote control code of the at least one sub video apparatus connected to the at lease one external input terminal of the main video apparatus, by selecting and setting a type, a name of a manufacturer, and a name of a model of the at least one sub video apparatus.

7. A remote controller according to claim 1, wherein the transmitting means comprises an operation key commonly shared by the at least one sub video apparatus to control the at least one sub video apparatus.

8. A remote controller according to claim 1, wherein the main video apparatus comprises a television receiver, and wherein the at least one sub video apparatus comprises an external video apparatus connected to the television receiver.

9. A remote controller comprising:
registering means for registering information of a remote control signal concerning a main video apparatus and at least one sub video apparatus respectively connected to at least one external input terminal on the main video apparatus;
transmitting means for transmitting the remote control signal in each of transmission modes of the main video apparatus and the at least one sub video apparatus based on the registration of the registering means;
selecting means for causing the transmitting means to transmit the remote control signal for selecting a signal to be captured into the main video apparatus through the external input terminal in response to a selection operation that is performed to select one of the at least one sub video apparatus as an external input source to the main video apparatus;
mode setting means for setting, in the transmitting means, the transmission mode of the at least one sub video apparatus from among the transmission modes corresponding to the selection operation, in response to the selection operation that is performed to select one of the at least one sub video apparatus as the external input source to the main video apparatus;
input switch means for switching the external input source to the main video apparatus in response to the remote control signal, transmitted from the transmitting means, for selecting the signal to be captured into the main video apparatus; and
remote control signal generating means for generating the remote control signal compatible with the transmission mode of the sub video apparatus set by the mode setting means and transmitted from the transmitting means.

10. A remote controller according to claim 9, wherein the remote control signal generator means comprises an infrared blaster, wherein the infrared blaster transmits the remote control signal to the at least one sub video apparatus.
